(19) United States
(12) Patent Application Publication
(10) Pub. No.: US 2019/0160585 A1
(43) Pub. Date: May 30, 2019

(54) METHOD OF CLEANING PORTION TO BE WELDED, WELDING SYSTEM, AND METHOD OF MANUFACTURING RING

(71) Applicant: AISIN AW CO., LTD., Anjo-shi, Aichi-ken (JP)

(72) Inventors: Yohei ITO, Anjo (JP); Masahiko KATSUDA, Anjo (JP)

(73) Assignee: AISIN AW CO., LTD., Anjo-shi, Aichi-ken (JP)

(21) Appl. No.: 16/321,526

(22) PCT Filed: Sep. 29, 2017
(86) PCT No.: PCT/JP2017/035693

§ 371 Date: Jan. 29, 2019

(30) Foreign Application Priority Data
Sep. 30, 2016 (JP) 2016-193381

(51) Int. Cl. B23K 10/02; B23K 31/10; B23K 37/053

(52) U.S. Cl. CPC B23K 10/027; B23K 37/053; B23K 31/10

(57) ABSTRACT

In a method for cleaning a portion to be welded in which a first portion (Pa) to be welded and a second portion (Pb) to be welded, which are to be joined by butt welding, are cleaned, the first and second portions (Pa, Ph) to be welded are cleaned before the butt welding by injecting, with the first and second portions (Pa, Pb) to be welded abutting on each other, plasma produced from a gas containing oxygen into a groove between the first portion (Pa) to be welded and the second portion Pb) to be welded.

### CROSS REFERENCE TO RELATED APPLICATIONS

This application is a National Stage of International Application No. PCT/JP2017/035693, filed Sep. 29, 2017, claiming priority based on Japanese Patent Application No. 2016-193381, filed Sep. 30, 2016.

### TECHNICAL FIELD

Aspects of the present disclosure relate to methods for cleaning a portion to be welded, welding systems, and methods for manufacturing a ring.

### BACKGROUND ART

Conventionally, cleaning methods in which foreign matter such as oil sticking to ends of a plate-like member, which are portions to be welded, is removed before butt welding of the ends have been proposed as methods for cleaning a portion to be welded. For example, Patent Document 1 describes a method in which a portion to be welded is cleaned by sliding a fiber member impregnated with an organic cleaning agent along the portion to be welded while pressing the fiber member thereagainst. Patent Document 2 describes a method in which a plate-like member is first bent into the shape of a pipe so that its ends abut on each other, high pressure cleaning water is then injected to the abutting ends to remove foreign matter, and drying air is subsequently blown from a drying nozzle onto the abutting ends. In addition to these methods, laser cleaning in which a portion to be welded is cleaned by irradiating the portion to be welded with laser light to sublimate foreign matter, dry ice cleaning in which a portion to be welded is cleaned by blasting dry ice onto foreign matter, etc. are also known in the art.

### RELATED ART DOCUMENTS

### Patent Documents

Patent Document 1: Japanese Patent Application Publication No. 2003-340590 (JP 2003-340590 A)

Patent Document 2: Japanese Patent Application Publication No. 2000-79491 (JP 2000-79491 A)

### SUMMARY

In the cleaning method of Patent Document 1, however, foreign matter may stick to the portion to be welded due to degradation of the fiber member etc. or liquid containing the organic cleaning agent may remain on the portion to be welded. In the cleaning method of Patent Document 2, since drying air is blown for drying after cleaning, water scattered by such blowing of drying air may remain on the portion to be welded. Both laser cleaning and dry ice cleaning can be used only for small and limited cleaning areas, and therefore require long cleaning time. Moreover, laser cleaning may have problems due to the influence of heat on the portion to be welded, and dry ice cleaning may have problems such as that pieces of foreign matter crushed by blasting of dry ice may stick again to the portion to be welded.

It is an aspect of the present disclosure to appropriately clean a portion to be welded so that oil, water, etc. do not remain thereon.

The present disclosure describes the following measures in order to achieve these aspects.

A method for cleaning a portion to be welded according to the present disclosure is a method for cleaning a portion to be welded in which a first portion to be welded and a second portion to be welded, which are to be joined by butt welding, are cleaned, wherein the first and second portions to be welded are cleaned before the butt welding by injecting, with the first and second portions to be welded abutting on each other, plasma produced from a gas containing oxygen into a groove between the first portion to be welded and the second portion to be welded.

In this method for cleaning a portion to be welded, the cleaning is performed by injecting, with the first and second portions to be welded, namely the portions to be welded, abutting on each other, plasma generated from a gas containing oxygen into the groove between the first portion to be welded and the second portion to be welded. Accordingly, oil sticking to the portions to be welded can be removed while causing carbon in the oil to react with oxygen in the plasma to produce carbon dioxide. Since this reaction is caused by the plasma at high temperatures, water produced by the reaction between hydrogen in the oil and oxygen in the plasma is vaporized into water vapor. Water can therefore be prevented from remaining on the portions to be welded. Since plasma can be emitted to a broad area as compared to laser light, cleaning can be efficiently performed. The portions to be welded can therefore be appropriately cleaned so that oil, water, etc. do not remain thereon.

### BRIEF DESCRIPTION OF THE DRAWINGS

FIG. 1 is a configuration diagram schematically showing the configuration of a continuously variable transmission 100.

FIG. 2 is a configuration diagram schematically showing the configuration of a transmission belt 110.

FIGS. 3A to 3M are illustrations showing an example of a manufacturing process of a ring.

FIG. 4 is a configuration diagram of a welding system 10 of the present disclosure.

FIG. 5 is a configuration diagram of a cleaning head 20.

FIG. 6 is an illustration showing how plasma PL is injected from a nozzle 27B of a comparative example.

FIGS. 7A and 7B are illustrations showing an example of a pre-weld cleaning process and a welding process of the welding system 10.

FIGS. 8A and 8B are illustrations showing a pre-weld cleaning process and a welding process of a modification.

### PREFERRED EMBODIMENTS

Modes for carrying out the various aspects of the present disclosure will be described with reference to the accompanying drawings.

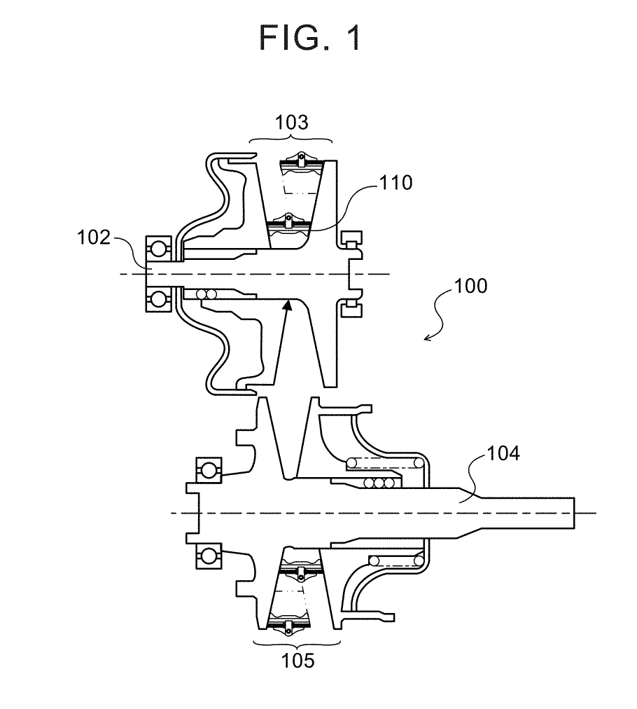

FIG. 1 is a configuration diagram schematically showing the configuration of a continuously variable transmission 100. The continuously variable transmission 100 is mounted on a vehicle including a power source such as an engine, and as shown in the figure, includes a primary shaft 102 serving as a drive-side rotary shaft, a primary pulley 103 provided on the primary shaft 102, a secondary shaft 104 disposed parallel to the primary shaft 102 and serving as a driven-side rotary shaft, a secondary pulley 105 provided on the secondary shaft 104, and a transmission belt 110 wound around a pulley groove (V-groove) of the primary pulley 103 and a pulley groove (V-groove) of the secondary pulley 105. The continuously variable transmission 100 changes the groove widths of the primary pulley 103 and the secondary pulley 105 and thus steplessly shifts power of the primary pulley 103 to transmit the shifted power to the secondary pulley 105.

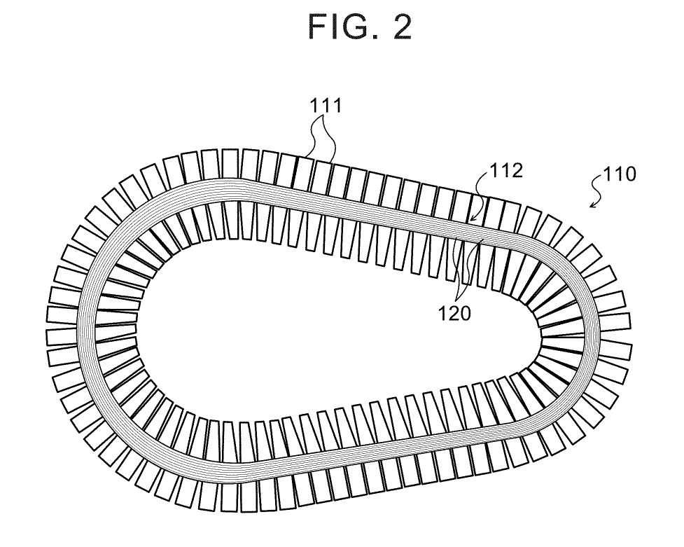

FIG. 2 is a configuration diagram schematically showing the configuration of the transmission belt 110. As shown in FIG. 2, the transmission belt 110 includes a multiplicity (e.g., several hundreds) of elements 111 and a laminated ring 112 and is formed by connecting the multiplicity of elements 111 into a ring shape by the laminated ring 112. For example, the elements 111 are parts punched out from a steel sheet by pressing. The elements 111 are subjected to a clamping force from the pulley (the primary pulley 103, the secondary pulley 105) at their right and left side surfaces, and those elements 111 which are located ahead in the traveling direction of the belt are pushed out by the friction force in the direction tangential to the pulley, whereby power is transmitted.

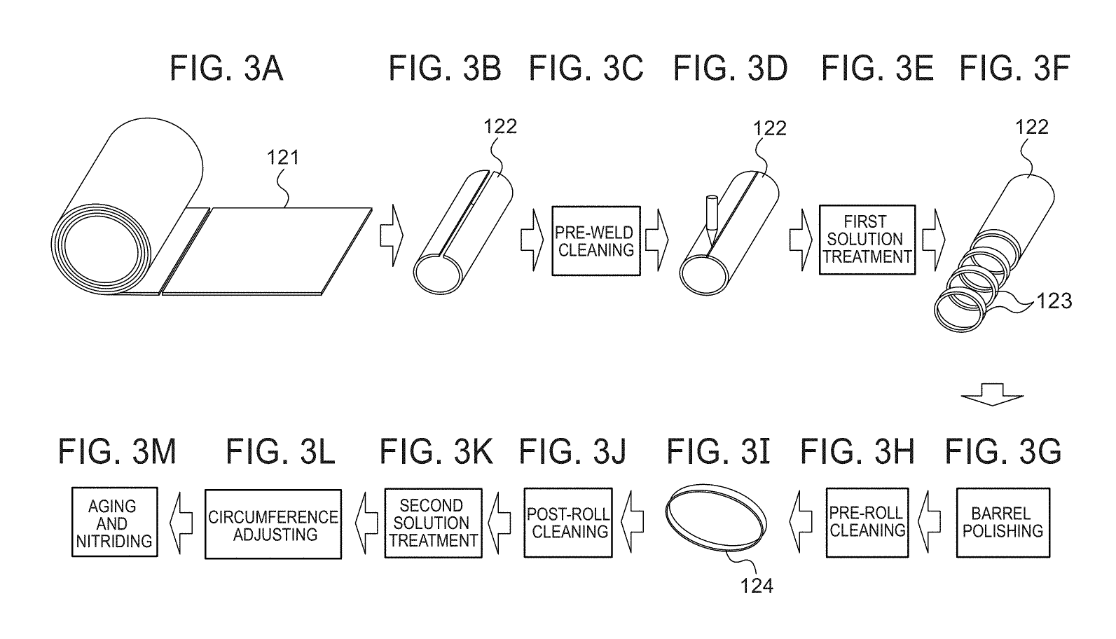

The laminated ring 112 is formed by laminating a plurality of endless metal rings 120 (single rings) having slightly different circumferences from each other in the radial direction. The laminated ring 112 is manufactured by a manufacturing process illustrated in FIGS. 3A to 3M.

The manufacturing process of the ring 120 is comprised of: (A) a strip cutting process (see FIG. 3A); (B) a bending process (see FIG. 3B); (C) a pre-weld cleaning process (see FIG. 3C); (D) a welding process (see FIG. 3D); (E) a first solution treatment process (annealing process) (see FIG. 3E); (F) a ring cutting process (see FIG. 3F); (G) a barrel polishing process (see FIG. 3G); (H) a pre-roll cleaning process (see FIG. 3H); (I) a rolling process (see FIG. 3I); (J) a post-roll cleaning process (see FIG. 3J); (K) a second solution treatment process (see FIG. 3K); (L) a circumference adjusting process (see FIG. 3L); and (M) an aging and nitriding process (see FIG. 3M).

(A) The strip cutting process is a process of cutting a strip steel (maraging steel) having a predetermined thickness (e.g., 0.4 to 0.5 mm) and wound around a drum in the lateral direction into strips 121 with a predetermined size. The strip cutting process can be performed by using a cutter cutting machine having a cutter edge, a laser cutting machine, etc. (B) The bending process is a process of bending the strip 121 into a tubular shape such that the ends of the strip 121 abut on each other, thereby forming a tubular body 122. The bending process can be performed by using a roll or a die.

(C) The pre-weld cleaning process is a process of degreasing and cleaning the tubular body 122 before welding the abutting portions of the tubular body 122. (D) The welding process is a process of performing butt welding, namely welding the abutting portions of the tubular body 122. (E) The first solution treatment process (annealing process) is a process that is performed in order to level hardness distribution around the weld, which has been changed by the welding process, to improve ductility.

(F) The ring cutting process is a process of cutting the tubular body 122 into a plurality of ring bodies 123 with a predetermined width, and this process can be performed by using a cutter cutting machine, a laser cutting machine, etc. (G) The barrel polishing process is a process of placing the ring bodies into a barrel containing an abrasive (abrasive stones) and vibrating and rotating the barrel to remove burrs or corners of the lateral ends of the ring bodies produced by the ring cutting process.

(H) The pre-roll cleaning process is a process of, before rolling the ring body 123, removing polishing debris etc. sticking to the ring body 123 in the barrel polishing process. (I) The rolling process is a process of rolling the ring body 123 to a required thickness with a rolling roller to produce a ring body 124. (J) The post-roll cleaning process is a process of removing rolling oil etc. sticking to the ring body 124 by the rolling. (K) The second solution treatment process is a process of heating the ring body 124 produced by the rolling to recrystallize a metallic structure deformed by the rolling.

(L) The circumference adjusting process is a process of finely adjusting the circumferences of a plurality of the ring bodies 124 produced by the rolling so that the ring bodies 124 can be laminated in the radial direction. (M) The aging and nitriding process is a process of aging the ring bodies 124 with the adjusted circumferences and then nitriding the ring bodies 124 to strengthen the surfaces of the ring bodies 124.

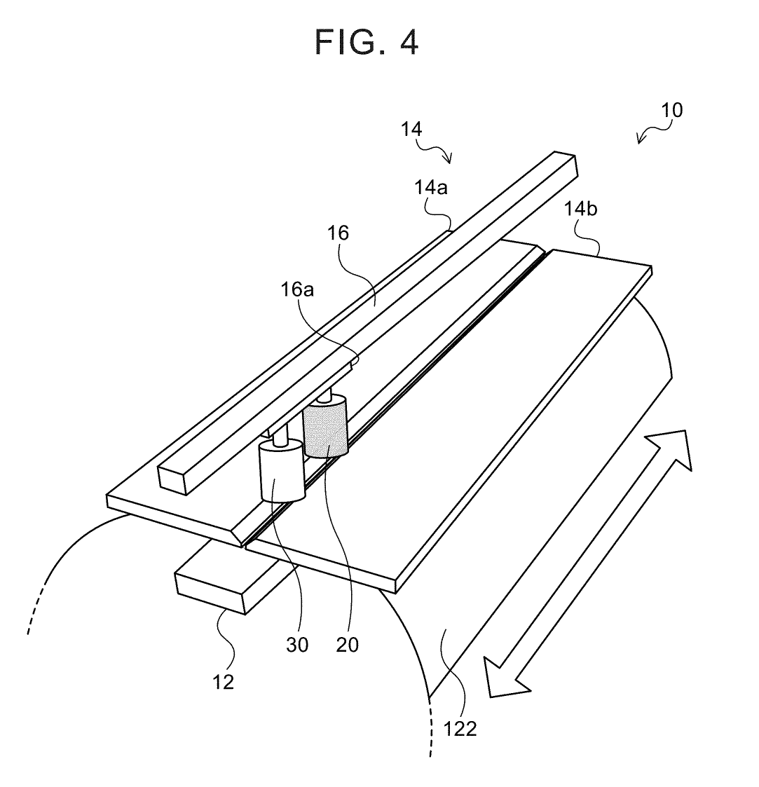

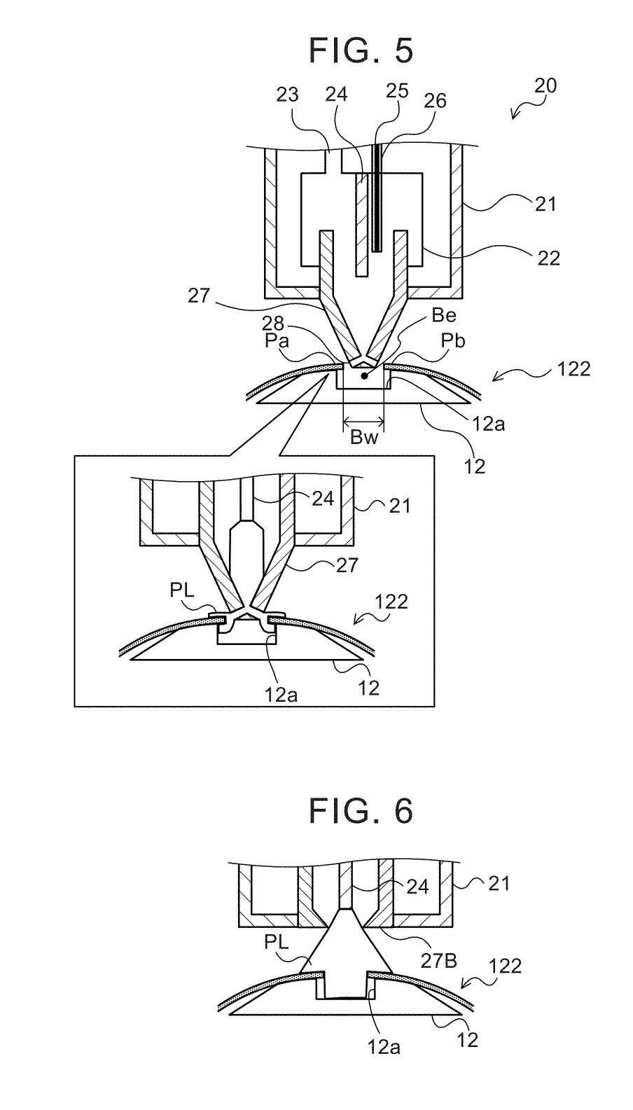

(C) The pre-weld cleaning process and (D) the welding process will be described in detail below. FIG. 4 is a configuration diagram of a welding system 10 of the present disclosure, and FIG. 5 is a configuration diagram of a cleaning head 20. As shown in FIG. 4, the welding system 10 of the present embodiment includes the cleaning head 20 for cleaning portions to be welded before welding and a welding head 30 for causing the portions to be welded to abut on each other to perform butt welding, and has a function to clean the portions to be welded before butt welding. This welding system 10 butt welds both ends (portions to be welded) in the circumferential direction of the tubular body 122 formed by bending the strip 121 (flat sheet).

The welding system 10 of the present embodiment is a system that performs both (C) the pre-weld cleaning process and (D) the welding process which are described above. Oil etc. having stuck to the strip 121 during rolling remains on the strip 121. In order to prevent formation of blowholes etc. during welding, it is necessary to clean a groove Be of the tubular body 122 before welding to remove the oil etc. For cleaning of the groove Be, it is desirable to clean not only the outer surfaces and end faces but also the inner surfaces of both ends in the circumferential direction of the tubular body 122.

As shown in FIGS. 4 and 5, the welding system 10 includes: a back electrode 12 that supports one end Pa and the other end Pb (hereinafter referred to as both ends Pa, Pb), which define the groove Be of the tubular body 122, from below (inside the tubular body 122); a pair of clamping jigs 14 (14a, 14b) that press both ends Pa, Pb from above; the cleaning head 20 that injects plasma toward the groove Be to perform plasma cleaning; the welding head 30 that butt welds the groove Be by, e.g., laser welding; and a moving device 16 that reciprocates the cleaning head 20 and the welding head 30 in the axial direction of the tubular body 122 (the directions shown by arrows in FIG. 4). The back electrode 12 has a recess 12a substantially in the middle in the lateral direction (left-right direction in FIG. 5) of its upper surface. With the back electrode 12 supporting the tubular body 122, the recess 12a extends along the groove Be. The welding head 30 is not limited to laser welding, and may perform other types of welding such as plasma arc welding and electron beam welding.

The clamping jigs 14 are driven by a driving mechanism, not shown. The clamping jigs 14 can be driven by the drive mechanism to perform: first stage clamping that makes the width Bw (see FIG. 5) of the groove Be relatively large so as to be suitable for plasma cleaning; and second stage clamping that makes the width Bw of the groove Be relatively small so as to be suitable for laser welding.

The moving device 16 is configured as a direct acting actuator that includes a drive motor, not shown, a ball screw connected to a rotary shaft of the drive motor to rotate with rotation of the drive motor, etc. and that moves a slider 16a in the axial direction of the ball screw (the direction shown by arrow in FIG. 4) by rotation of the ball screw. The cleaning head 20 and the welding head 30 are mounted on the lower surface of the slider 16a so as to be arranged next to each other in the direction in which the slider 16a moves. The moving device 16 moves the slider 16a to move the cleaning head 20 and the welding head 30 along the groove Be in the axial direction of the tubular body 122. The moving device 16 is not limited to the device in which the slider 16a moves only in the axial direction of the ball screw. The moving device 16 may be configured so that, in the case where the X direction is, e.g., the axial direction of the ball screw, the slider 16a moves in the Y direction (left-right direction) perpendicular to the X direction in a horizontal plane or the slider 16a moves (moves up and down) in the Z direction (up-down direction), namely the vertical direction, and the moving device 16 with such a configuration is preferred.

As shown in FIG. 5, the cleaning head 20 includes a tubular housing 21 that partially opens in the center of the bottom, a chamber 22 which is disposed in the housing 21 and in which a plasma generation process is performed, and a nozzle 27 that projects through the lower opening of the housing 21 and injects plasma generated in the chamber 22 downward. The chamber 22 is provided with a gas pipe 23 that supplies a reactive gas into the chamber 22, a plasma electrode 24 connected to a high frequency power supply, not shown, an ignition wire 25 disposed near the plasma electrode 24 and connected to a high voltage power supply, not shown, and an insulating tube 26 made of a ceramic etc. that is an insulating material and covering the ignition wire 25. For example, the reactive gas that is supplied through the gas pipe 23 into the chamber 22 is a gas containing oxygen such as oxygen gas or Clean DryAir (CDA). The cleaning head 20 of the present embodiment is so-called atmospheric-pressure plasma that generates plasma with the pressure inside the chamber 22 being equal to the atmospheric pressure. The nozzle 27 is made of quartz etc. and has such a tapered shape that the outside diameter of the nozzle 27 decreases as it gets farther away from its base end accommodated in the housing 21 and closer to its tip end having an injection port 28. The outside diameter of the tip end of the nozzle 27 is smaller than the width Bw of the groove Be resulting from the first stage clamping of the clamping jigs 14, and the injection port 28 in the tip end is located within the groove Be.

In the cleaning head 20, the reactive gas such as oxygen gas or CDA is supplied through the gas pipe 23 into the chamber 22, and with a high frequency voltage from the high frequency power supply being applied to the plasma electrode 24, a high voltage from the high voltage power supply is applied to the ignition wire 25. A discharge thus occurs between the plasma electrode 24 and the ignition wire 25, and plasma of the reactive gas in the chamber 22 starts being generated. Since the high frequency voltage is applied to the plasma electrode 24, high density plasma PL is injected from the injection port 28 of the nozzle 27 and emitted into the groove Be (an enlarged view in FIG. 5). As described above, since the injection port 28 in the tip end of the nozzle 27 is located within the groove Be, the injected plasma PL is emitted not only to the outer surfaces and the end faces but also the inner surfaces of both ends Pa, Pb of the tubular body 122 which define the groove Be. FIG. 6 is an illustration showing how plasma PL is injected from a nozzle 27B of a comparative example. Unlike the nozzle 27 of the present embodiment, the nozzle 27B of the comparative example does not project from the lower part of the housing 21 and the tip end of the nozzle 27B is not located within the groove Be. The plasma PL injected from the nozzle 27B of the comparative example is emitted to a relatively broad area of the outer surface of the tubular body 122. As compared to this comparative example, in the present embodiment, the plasma PL can be efficiently emitted also to the inner surface of the tubular body 122.

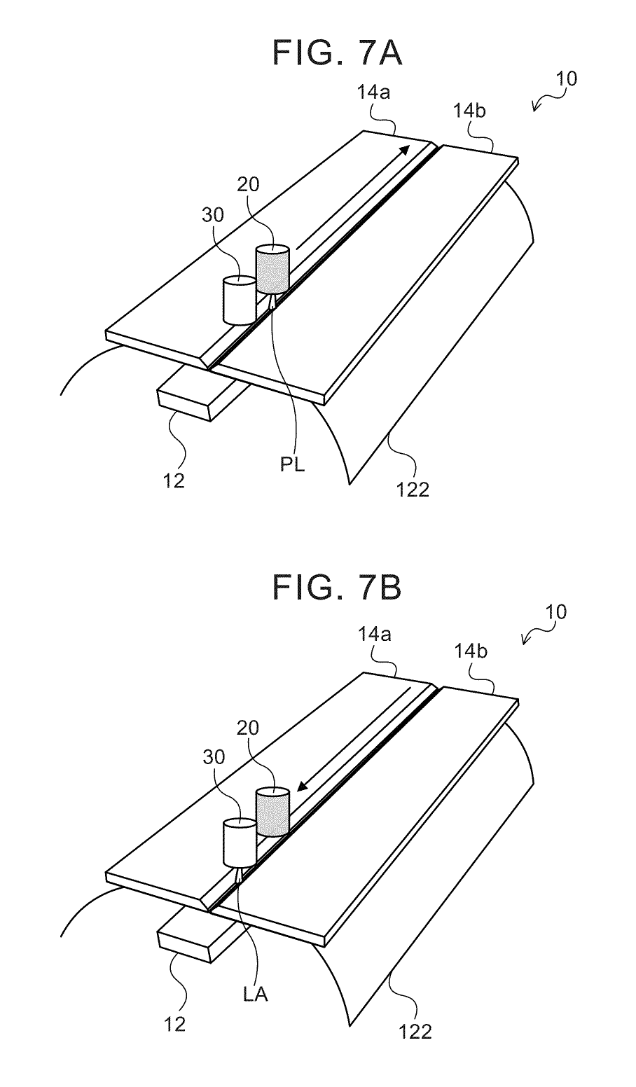

The welding system 10 configured as described above performs (C) the pre-weld cleaning process and (D) the welding process as follows. FIGS. 7A and 7B are illustrations showing an example of the pre-weld cleaning process and the welding process of the welding system 10. First, the tubular body 122 is set on the back electrode 12 such that the groove Be of the tubular body 122 is aligned with the recess 12a, and the first stage clamping is performed with the clamping jigs 14 to fix the tubular body 122. Next, as shown in FIG. 7A, with plasma PL being injected from the nozzle 27 of the cleaning head 20 toward the groove Be, the slider 16a is moved to the side away from the viewer of the figure by the moving device 16 to move the cleaning head 20 and the welding head 30 forward. When the plasma PL injected from the nozzle 27 is emitted to both ends Pa, Pb of the tubular body 122 which define the groove Be, carbon and hydrogen which are contained in oil etc. on the surfaces of both ends Pa, Pb react with oxygen in the plasma PL to produce carbon dioxide and water vapor (water). Since such a reaction by the plasma PL is caused at high temperatures such as several hundreds of degrees Celsius or more, the generated water is vaporized into water vapor. The surfaces of both ends Pa, Pb of the tubular body 122 can thus be degreased and cleaned and water can be prevented from remaining on the surfaces of both ends Pa, Pb of the tubular body 122, which eliminates the need for a drying process after cleaning. Since plasma PL can be efficiently emitted also to the inner surfaces of the tubular body 122 as described above, not only the outer surfaces and the end faces but also the inner surfaces of both ends Pa, Pb can be reliably cleaned. Moreover, since the recess 12a of the back electrode 12 is located below the groove Be, plasma PL can be emitted only to an area required for welding. That is, plasma PL reaches the inner surfaces of both ends Pa, Pb and is emitted to a required area without excessively diffusing below the groove Be. Cleaning efficiency can thus be enhanced.

In the welding system 10, when the cleaning head 20 moves to a forward movement end located on the side away from the viewer of FIG. 7A while performing plasma cleaning, injection of plasma PL from the nozzle 27 of the cleaning head 20 is terminated, and the second stage clamping is performed with the clamping jigs 14 to further reduce the width of the groove Be. As shown in FIG. 7B, while laser welding is being performed with laser light LA being emitted from the welding head 30 into the groove Be, the slider 16a is moved to the side closer to the viewer of the figure by the moving device 16 to move the cleaning head 20 and the welding head 30 backward. (C) Plasma cleaning in the pre-weld cleaning process and (D) butt welding in the welding process can thus be performed by causing the cleaning head 20 and the welding head 30 to make one reciprocating movement. By the plasma cleaning before welding, not only the outer surfaces and the end faces but also the inner surfaces are degreased and no water remains thereon. Formation of blowholes during butt welding can thus be prevented and welding can be reliably performed. Since the plasma cleaning is performed with the tubular body 122 being fixed by jigs required for welding such as the back electrode 12 and the clamping jigs 14, and the tubular body 122 need not be moved to a separate welding position after cleaning and set in position again, a series of processes from cleaning to welding can be effectively performed. In the case where the moving device 16 is configured so that the slider 16a can move in the left-right direction as described above, misalignment between the groove Be (the tubular body 122) and the head (the cleaning head 20 or the welding head 30) can be easily corrected. In the case where the moving device 16 is configured so that the slider 16a can move in the up-down direction, the distance between the groove Be (the tubular body 122) and the head (the cleaning head 20 or the welding head 30) can be easily corrected. Cleaning and welding can thus be appropriately performed with misalignment of the groove Be corrected and with the distance corrected so as to be suitable for cleaning and welding.

In the method for cleaning a portion to be welded according to the present disclosure described above, before butt welding of both ends Pa, Pb of the tubular body 122, plasma PL is injected into the groove Be with both ends Pa, Pb abutting on each other, thereby cleaning both ends Pa, Pb. Oil sticking to both ends Pa, Pb can thus be removed while causing carbon in the oil to react with oxygen in the plasma PL to produce carbon dioxide. Water produced by the reaction between hydrogen in the oil and oxygen in the plasma PL is vaporized into water vapor. Water can therefore be prevented from remaining, which eliminates the need for a drying process after cleaning. Both ends Pa, Pb can thus be appropriately cleaned so that oil, water, etc. do not remain thereon.

In the method for cleaning a portion to be welded according to the present disclosure, plasma PL is injected from the nozzle 27 whose tip end having the injection port 28 has a smaller width than the width Bw of the groove Be. Accordingly, the plasma PL can be efficiently emitted also to the inner surfaces of both ends Pa, Pb for cleaning.

In the method for cleaning a portion to be welded according to the present disclosure, plasma cleaning is performed with both ends Pa, Pb of the tubular body 122 being fixed by the fixing jigs to be used for butt welding (the back electrode 12 and the clamping jigs 14). Accordingly, butt welding can be promptly started after plasm cleaning.

In the method for cleaning a portion to be welded according to the present disclosure, plasma cleaning is performed with the groove Be between both ends Pa, Pb being widened by the clamping jigs 14 as compared to the groove Be during welding.

Accordingly, cleaning with plasma PL can be efficiently performed. Moreover, butt welding can be promptly started by merely performing the second stage clamping with the clamping jigs 14 to reduce the width of the groove Be.

In the method for cleaning a portion to be welded according to the present disclosure, plasma cleaning is performed with both ends Pa, Pb made to abut on each other by using the back electrode 12 capable of supporting both ends Pa, Pb of the tubular body 122 from below and having the recess 12a formed so as to extend along the groove Be. Accordingly, the cleaning area of the inner surfaces of both ends Pa, Pb can be narrowed and cleaning can be efficiently performed.

The welding system 10 of the present disclosure includes the cleaning head 20 that performs plasma cleaning, the welding head 30 that performs butt welding by laser welding, and the moving device 16 that moves the cleaning head 20 and the welding head 30 along the groove Be. Since no drying process is required after removing oil by plasma cleaning, a series of processes from cleaning to welding can be efficiently performed with a compact system configuration that incorporates cleaning equipment and welding equipment into one.

In the welding system 10 of the present disclosure, the outside diameter of the tip end of the nozzle 27 is smaller than the width Bw of the groove Be. However, the present disclosure is not limited to this. The outside diameter of the tip end of the nozzle 27 may be larger than the width Bw of the groove Be, and the injection port 28 may be disposed above the groove Be. The nozzle 27 is not limited to such a shape that its tip end projects through the lower opening of the housing 21. The nozzle 27 may have such a shape as shown in the comparative example of FIG. 6.

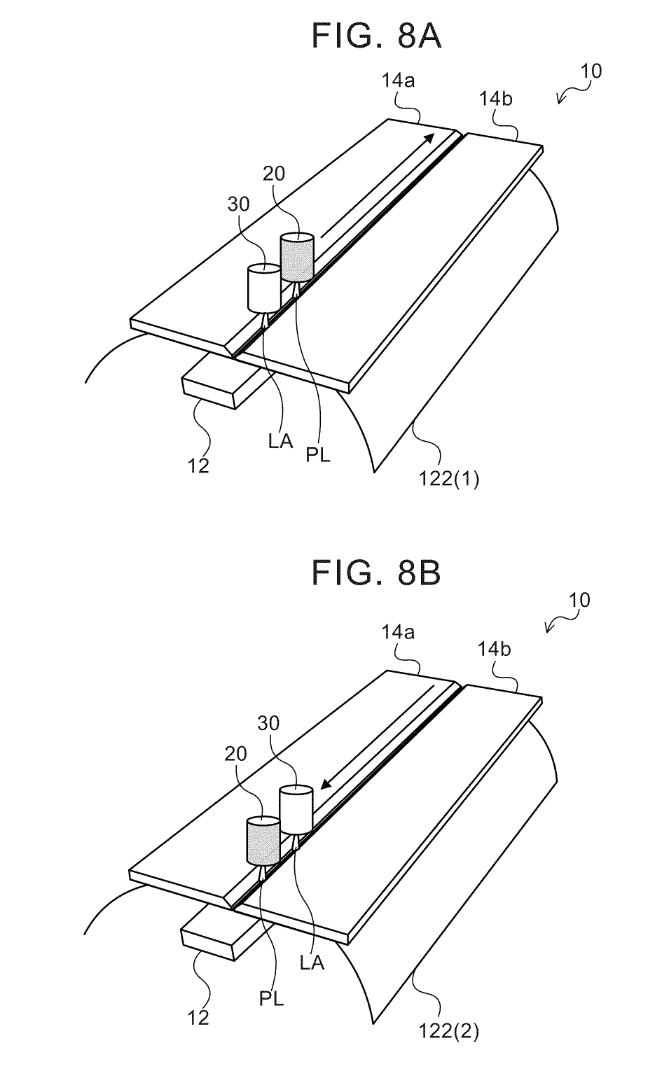

The welding system 10 of the present disclosure performs plasma cleaning by the cleaning head 20 when the slider 16a moves forward, and performs laser welding by the welding head 30 when the slider 16a moves backward. That is, the welding system 10 of the present disclosure performs the cleaning process and the welding process per pass. However, the present disclosure is not limited to this. FIGS. 8A and 8B are illustrations showing a cleaning process and a welding process in a modification.

As shown in FIG. 8A, when the slider 16a moves forward, laser welding is performed with laser light LA being emitted from the following welding head 30 into a groove Be of a tubular body 122(1) while plasma cleaning is being performed with plasma PL being emitted from the preceding cleaning head 20 into the groove Be. The cleaning process and the welding process are thus completed by one forward movement of the cleaning head 20 and the welding head 30. That is, the cleaning process and the welding process for the tubular body 122(1) can be performed in one pass. A series of processes from cleaning to welding can thus be more efficiently performed. In this case, the clamping jigs 14 perform the second stage clamping so that the groove Be of the tubular body 122(1) has a width Bw adjusted for welding. In the case where the cleaning process is performed in this state, it is difficult to reliably clean the inner surface of the tubular body 122(1). However, if, for example, the inner surface has only a small amount of oil sticking thereto, plasma cleaning can be performed to an extent that does not adversely affect welding.

When the forward movement of the slider 16a is completed, the tubular body 122(1) is removed and the next tubular body 122(2) is set in position. The positions of the cleaning head 20 and the welding head 30 are switched so that the cleaning head 20 precedes the welding head 30 during backward movement. In this case, for example, a plate capable of rotating (being turned around) relative to the slider 16a by at least 180 degrees in the horizontal direction and reciprocating with the slider 16a is mounted on the lower part of the slider 16a, and the cleaning head 20 and the welding head 30 are mounted on the plate. As shown in FIG. 8B, when the slider 16a moves backward, laser welding is performed with laser light LA being emitted from the following welding head 30 into a groove Be of the tubular body 122(2) while plasma cleaning is being performed with plasma PL being emitted from the preceding cleaning head 20 into the groove Be. Since the cleaning process and the welding process can thus be performed on different tubular bodies 122(1), 122(2), . . . in each pass of the forward movement and the backward movement of the slider 16a, production efficiency can further be improved.

In the welding system 10 of the present disclosure, the cleaning head 20 and the welding head 30 are moved with the tubular body 122 being fixed. However, the present disclosure is not limited to this. For example, the tubular body 122 may be moved with the cleaning head 20 and the welding head 30 being fixed.

The welding system 10 of the present disclosure performs plasma cleaning and laser welding at the same position without moving the tubular body 122 set in position. However, the present disclosure is not limited to this. The welding system 10 may perform plasma cleaning and laser welding at different positions. In this case, separate moving devices are provided for the cleaning head 20 and the welding head 30. At the cleaning position, the welding system 10 performs plasma cleaning with the tubular body 122 being fixed by a jig different from that for welding. That is, the present disclosure is not limited to the welding system that performs plasma cleaning with the tubular body 122 being fixed by the back electrode 12 and the clamping jigs 14. The welding system of the present disclosure may perform plasma cleaning with the tubular body 122 being fixed by a jig exclusively for plasma cleaning. For example, the tubular body 122 is fixed by a support jig capable of supporting the tubular body 122 from below and having a recess formed so as to extend along the groove and a clamping jig capable of clamping both ends of the tubular body 122 from above.

The illustrated welding system 10 of the present disclosure performs plasma cleaning before butt welding of the tubular body 122 having a cylindrical shape.

However, the present disclosure is not limited to this. For example, the welding system 10 may perform plasma cleaning before butt welding of a tubular member in the shape of a rectangular tube. Alternatively, the present disclosure is not limited to plasma cleaning that is performed before butt welding of a tubular member, and may be applied to, e.g. plasma cleaning that is performed before ends of two flat sheets are made to abut on each other and are butt welded.

In the manufacturing process of the present disclosure, the bending process, the cleaning process (pre-weld cleaning process), the welding process, and the cutting process (ring cutting process) are performed in this order. However, the present disclosure is not limited to this. For example, the cutting process, the bending process, the cleaning process, and the welding process may be performed in this order. In this case, for example, a strip is cut into elongated pieces with a predetermined width in the cutting process, and each elongated piece is bent into a ring shape in the bending process such that the shorter sides of the elongated piece, namely both ends thereof, abut on each other. The abutting portions of both shorter sides (both ends) are then cleaned in the cleaning process, and the abutting portions are welded in the welding process.

As described above, a method for cleaning a portion to be welded according to the present disclosure is a method for cleaning a portion to be welded in which a first portion (Pa) to be welded and a second portion (Pb) to be welded, which are to be joined by butt welding, are cleaned, wherein the first and second portions (Pa, Pb) to be welded are cleaned before the butt welding by injecting, with the first and second portions (Pa, Pb) to be welded abutting on each other, plasma (PL) produced from a gas containing oxygen into a groove (Be) between the first portion (Pa) to be welded and the second portion (Pb) to be welded.

Oil sticking to the portions (Pa, Pb) to be welded can thus be removed while causing carbon in the oil to react with oxygen in the plasma (PL) to produce carbon dioxide. Since this reaction is caused by the plasma (PL) at high temperatures, water produced by the reaction between hydrogen in the oil and oxygen in the plasma is vaporized into water vapor. Water can therefore be prevented from remaining in the groove.

In the method for cleaning a portion to be welded, the first portion (Pa) to be welded may be one end in a circumferential direction of a tubular member (122) formed by bending a flat sheet into a tubular shape, and the second portion (Pb) to be welded may be the other end in the circumferential direction of the tubular member (122).

In the method for cleaning a portion to be welded, the cleaning may be performed by injecting the plasma (PL) from a nozzle (27) whose tip end having an injection port (28) has an outside diameter smaller than a width (Bw) of the groove (Be).

In the method for cleaning a portion to be welded, the cleaning may be performed with the first and second portions (Pa, Pb) to be welded being fixed by a fixing jig (12, 14) that fixes the first and second portions (Pa, Pb) to be welded when the butt welding is performed.

In the method for cleaning a portion to be welded, the cleaning may be performed with the first and second portions (Pa, Pb) to be welded being clamped such that the groove (Be) is widened as compared to the groove (Be) during the butt welding by using as the fixing jig a clamping jig (14) that clamps the first and second portions (Pa, Pb) to be welded from above when the butt welding is performed.

In the method for cleaning a portion to be welded, the cleaning may be performed with the first and second portions (Pa, Pb) to be welded being supported by using as the fixing jig a support jig (12) configured to support the first and second portions (Pa, Pb) to be welded from below and having a recess (12a) formed so as to extend along the groove (Be).

A welding system of the present disclosure is a welding system (10) that performs butt welding, including: a cleaning head (20) that cleans a first portion (Pa) to be welded and a second portion (Pb) to be welded, which are portions to be welded, by injecting, with the first and second portions (Pa, Pb) to be welded abutting on each other, plasma (PL) produced from a gas containing oxygen into a groove (Be) between the first portion (Pa) to be welded and the second portion (Pb) to be welded; a welding head (30) that performs butt welding of the first and second portions (Pa, Pb) to be welded; and a moving device (16) that moves the cleaning head (20) and the welding head (30) relative to the groove (Be), wherein after the cleaning is performed by moving the groove (Be) and the cleaning head (20) relative to each other by the moving device (16), the groove (Be) and the welding head (30) are moved relative to each other by the moving device (16) to perform the butt welding.

The butt welding by the welding head can thus be performed without going through a drying process after the plasma cleaning by the cleaning head. Accordingly, a series of processes from cleaning to welding can be efficiently performed.

A method for manufacturing a ring according to the present disclosure is a method for manufacturing an endless metal ring (120) for a continuously variable transmission using a transmission belt (110) formed by connecting a plurality of elements (111) by the ring (120), including: a bending step (B) of bending a strip (121) into a tubular shape such that both ends of the strip (121) abut on each other; a cleaning step (C) of cleaning a first portion (Pa) to be welded, which is one of the both ends, and a second portion (Pb) to be welded, which is the other of the both ends, by injecting, with the first portion (Pa) to be welded and the second portion (Pb) to be welded abutting on each other, plasma (PL) produced from a gas containing oxygen into a groove (Be) between the first portion (Pa) to be welded and the second portion (Pb) to be welded; and a welding step (D) of performing welding with the first portion (Pa) to be welded and the second portion (Pb) to be welded abutting on each other.

The butt welding by the welding head can thus be performed without going through a drying process after the plasma cleaning by the cleaning head. Accordingly, the ring can be efficiently manufactured. Any oil or water remaining on the portions to be welded can cause formation of blowholes as the oil or water is vaporized during welding. In this manufacturing method, however, oil such as anti-rust oil on the portions to be welded can be appropriately removed, and water does not remain on the portions to be welded. Formation of blowholes can thus be prevented and welding can be reliably performed. The ring with high strength can thus be easily manufactured.

The method for manufacturing an endless metal ring may further include: a cutting step of cutting the welded tubular body into a plurality of ring bodies. This cutting step can be performed after the welding step. However, the present disclosure is not limited to this. For example, the cutting step may be performed before the bending step.

The invention of the present disclosure is not limited in any way to the above embodiment, and it is to be understood that various modifications may be made without departing from the spirit and scope of the present disclosure. The above embodiment merely shows a specific form of the invention described in the section “SUMMARY” and is not intended to limit the elements of the invention described in the section “SUMMARY”

### INDUSTRIAL APPLICABILITY

The invention of the present disclosure can be utilized in various industries in which butt welding of portions to be welded is performed, etc.

1-9. (canceled)

10. A method for cleaning a portion to be welded in which a first portion to be welded and a second portion to be welded, which are to be joined by butt welding, are cleaned, wherein
the first and second portions to be welded are cleaned before the butt welding by injecting, with the first and second portions to be welded abutting on each other, plasma produced from a gas containing oxygen into a groove between the first portion to be welded and the second portion to be welded.

11. The method for cleaning a portion to be welded according to claim 10, wherein
the first portion to be welded is one end in a circumferential direction of a tubular member formed by bending a flat sheet into a tubular shape, and the second portion to be welded is the other end in the circumferential direction of the tubular member.

12. The method for cleaning a portion to be welded according to claim 11, wherein
the cleaning is performed by injecting the plasma from a nozzle whose tip end having an injection port has an outside diameter smaller than a width of the groove.

13. The method for cleaning a portion to be welded according to claim 12, wherein
the cleaning is performed with the first and second portions to be welded being fixed by a fixing jig that fixes the first and second portions to be welded when the butt welding is performed.

14. The method for cleaning a portion to be welded according to claim 13, wherein
the cleaning is performed with the first and second portions to be welded being clamped such that the groove is widened as compared to the groove during the butt welding by using as the fixing jig a clamping jig that clamps the first and second portions to be welded from above when the butt welding is performed.

15. The method for cleaning a portion to be welded according to claim 13, wherein
the cleaning is performed with the first and second portions to be welded being supported by using as the fixing jig a support jig configured to support the first and second portions to be welded from below and having a recess formed so as to extend along the groove.

16. The method for cleaning a portion to be welded according to claim 14, wherein
the cleaning is performed with the first and second portions to be welded being supported by using as the fixing jig a support jig configured to support the first and second portions to be welded from below and having a recess formed so as to extend along the groove.

17. The method for cleaning a portion to be welded according to claim 11, wherein
the cleaning is performed with the first and second portions to be welded being fixed by a fixing jig that fixes the first and second portions to be welded when the butt welding is performed.

18. The method for cleaning a portion to be welded according to claim 17, wherein
the cleaning is performed with the first and second portions to be welded being clamped such that the groove is widened as compared to the groove during the butt welding by using as the fixing jig a clamping jig that clamps the first and second portions to be welded from above when the butt welding is performed.

19. The method for cleaning a portion to be welded according to claim 17, wherein
the cleaning is performed with the first and second portions to be welded being supported by using as the fixing jig a support jig configured to support the first and second portions to be welded from below and having a recess formed so as to extend along the groove.

20. The method for cleaning a portion to be welded according to claim 18, wherein
the cleaning is performed with the first and second portions to be welded being supported by using as the fixing jig a support jig configured to support the first and second portions to be welded from below and having a recess formed so as to extend along the groove.

21. A welding system that performs butt welding, comprising:
a cleaning head that cleans a first portion to be welded and a second portion to be welded, which are portions to be welded, by injecting, with the first and second portions to be welded abutting on each other, plasma produced from a gas containing oxygen into a groove between the first portion to be welded and the second portion to be welded;
a welding head that performs butt welding of the first and second portions to be welded; and
a moving device that moves the cleaning head and the welding head relative to the groove, wherein
after the cleaning is performed by moving the groove and the cleaning head relative to each other by the moving device, the groove and the welding head are moved relative to each other by the moving device to perform the butt welding.

22. A method for manufacturing an endless metal ring for a continuously variable transmission using a transmission belt formed by connecting a plurality of elements by the ring, comprising:
a bending step of bending a strip into a tubular shape such that both ends of the strip abut on each other;
a cleaning step of cleaning a first portion to be welded, which is one of the both ends, and a second portion to be welded, which is the other of the both ends, by injecting, with the first portion to be welded and the second portion to be welded abutting on each other, plasma produced from a gas containing oxygen into a groove between the first portion to be welded and the second portion to be welded; and
a welding step of performing welding with the first portion to be welded and the second portion to be welded abutting on each other.

23. The method for manufacturing an endless metal ring according to claim 22, further comprising:
a cutting step of cutting the welded tubular body into a plurality of ring bodies.
